(19) United States
(12) Patent Application Publication
(10) Pub. No.: US 2016/0271782 A1
(43) Pub. Date: Sep. 22, 2016

(54) Protective Tool Cover

(71) Applicant: 3 OF US PTY LTD, Glen Iris, Victoria (AU)

(72) Inventors: Steven Piritidis, Oakleigh, Victoria (AU); Michael Andrew Perceval, Asburton (AU)

(73) Assignee: 3 OF US PTY LTD, Glen Iris, Victoria (AU)

(21) Appl. No.: 15/033,978

(22) PCT Filed: Nov. 11, 2014
(86) PCT No.: PCT/AU2014/001038

§ 371 Date: May 3, 2016

(30) Foreign Application Priority Data
Nov. 11, 2013 (AU) 2013904346

(51) Int. Cl. B25F 5/02; F16F 1/36; F16F 7/00; B25C 1/06; B24B 55/05

(52) U.S. Cl. CPC B25F 5/02; B25C 1/06; B24B 55/05; F16F 7/003; F16F 1/36; F16F 2230/0023

(57) ABSTRACT

A protective cover for a power tool includes an impact absorbing boot configured to fit the genus of the power tool. The boot is adapted to cover the damage prone regions of the power tool and has an opening for inserting the tool and a fixer traversing the opening.

### INTRODUCTION TO INVENTION

This invention relates to hand held and operated power tools and in particular to a protective cover or guard adapted for easy fitting to a range of power tools so as to afford physical impact protection for the tool in the event of accidental misuse.

### BACKGROUND TO INVENTION

The construction industry relies on constant use of a multitude of portable power tools used on site ranging from saws, drills, nail guns, planers, spray equipment etc. Such power tools operated by way of a range of means including mains power electric supply, pneumatic power supply, gas fuel cell powered, explosive powered and an ever increasing use of batteries as a source of power has seen virtually every operation on a construction and building site undertaken by a dedicated power tool of some description.

The extensive use of such power tools in the construction industry has placed a high demand on the reliability and durability of such equipment which is often subject to use in harsh and uncontrolled environments. Such tools can be subject to occasional misuse or accidents which can find tools dropped or knocked about in the course of day to day activity. Whilst such power tools are generally made of robust materials including reinforced plastic and the like they are still subject to damaged caused by dropping from heights of over a metre during construction activity including carpentry framing, roof framing, etc. Moreover, the use of concrete slab constructions for flooring and the like will often find the inadvertent dropping of such power tools from a height onto a concrete substrate inflicting serious damage and often destructive damage to such tools with the cost of such incidents adding to the general cost of construction in addition to adding to the inconvenience and down time associated with such damage.

One particular example of such a tool is the gas fired framing nail gun. These tools find use in elevated positions on roof framing sites and can be prone to accidental dropping if dislodged from the users belt clip. Such tools incorporate close tolerance activation and firing mechanisms with a piston driven driver blade traversing a cylinder under high pressure from a gas fuel cell. The extreme pressures require a close tolerance fit which can be irreparably damaged if the tool is dropped from a height onto a concrete slab floor or the like.

It would be desirable to provide additional protection to such power tools and in particular protection against impact damage in the event of unintentional dropping or knocking of such tools. In particular, it would be desirable to provide a generic form of protective cover adapted for use on a wide range of various power tool types or genus designed to minimize any interference with the use of the tool in question.

Accordingly, one advantage of this invention is to provide an improved protective cover for a power tool or the like.

Any discussion of documents, acts, materials, devices, articles or the like which has been included in the present specification is not to be taken as an admission that any or all of these matters form part of the prior art base or were common general knowledge in the field relevant to the present invention as it existed before the priority date of each claim of this application.

### STATEMENT OF INVENTION

The invention provides a protective cover for a power tool, comprising an impact absorbing boot configured to fit the genus of said power tool, said boot being adapted to cover the damage prone regions of said power tool, said boot having an opening for inserting said tool and having a fixing means traversing said opening.

The boot may be formed of a compliant material providing said impact absorption and adapted for repeated use.

Alternatively, the boot may be formed of a deformable material adapted to absorb said impact by deformation and not generally intended for repeated use.

The cover may comprise a primary and a secondary layer, at least one of said layers being formed of an impact absorbing material.

A cavity may be formed between the primary and secondary layers of the boot.

The cavity may be configured to retain heating or cooling means therein.

The fixing means may be fitted to either side of said opening and may include an adjustment means to draw the boot into close proximity to said power tool and ensure snug fitting of said cover to said power tool.

In some embodiments, the fixing means may include an adjuster to draw the boot into close proximity to said power tool and ensure snug fitting of said cover to said power tool.

In one embodiment, the cover may further comprise an air outlet filter associated with said boot.

The air outlet filter may include a plurality of fine bristles adapted to conform to the shape of the air output region of said tool.

The air outlet filter may be U-shaped and fitted to a first end of said boot.

In another embodiment, the cover may further include a reinforcing member of compliant material at the first and/or second ends thereof to provide additional impact resistance at the highest damage prone region of said tool.

The reinforcing member may comprise a ring.

The reinforcing member may be configured to allow air flow therethrough.

In some embodiments, the cover may further comprise an air inlet filter at a second end of said boot.

The air inlet filter may comprise a mesh screen to filter particulate matter, wood shavings, chips and the like.

The reinforcing member may comprise the air inlet filter.

The air inlet filter may comprise a plurality of layers of mesh screen, each layer configured to be displaceable relative to the other.

In some embodiments the boot may include a battery access port.

In other embodiment, the boot may comprise a side air vent.

### BRIEF DESCRIPTION OF THE DRAWINGS

Embodiments of the invention are illustrated by way of example, and not by way of limitation, with reference to the accompanying drawings, in which:

FIG. 1 is a side view of a protective cover according to a first embodiment of the invention for a gas powered nail gun;

FIG. 2 shows the cover in FIG. 1 as applied to a gas powered nail gun;

FIG. 3 shows the air outlet filter;

FIG. 4 shows the air inlet filter;

FIG. 5 illustrates a side view of a second and a third embodiment of the invention for two different sizes of tool;

FIG. 6 illustrates an end on perspective view of the covers of FIG. 5;

FIG. 7 is a side view of a cover for a fixer tool;

FIG. 8 is a top view of the cover of FIG. 7;

FIG. 9 is a side view of a cover for a framer tool, positioned around a framer tool;

FIG. 10 is a side view of the cover of FIG. 9 detached from the framer tool;

FIG. 11 is a bottom view of the cover of FIGS. 9 and 10, illustrating a reinforcing member of the cover;

FIG. 12 is a bottom view of the first end of the fixer tool of FIGS. 7 and 8, illustrating a fixing strap locating the cover; and

FIG. 13 is a plan view of the reinforcing member of the cover from FIGS. 9 and 10, illustrating an air filtering means.

Like parts within this description will be identified with like numerals with it being understood that the description of the like parts of the first embodiment applies to the second embodiment, unless stated to be otherwise.

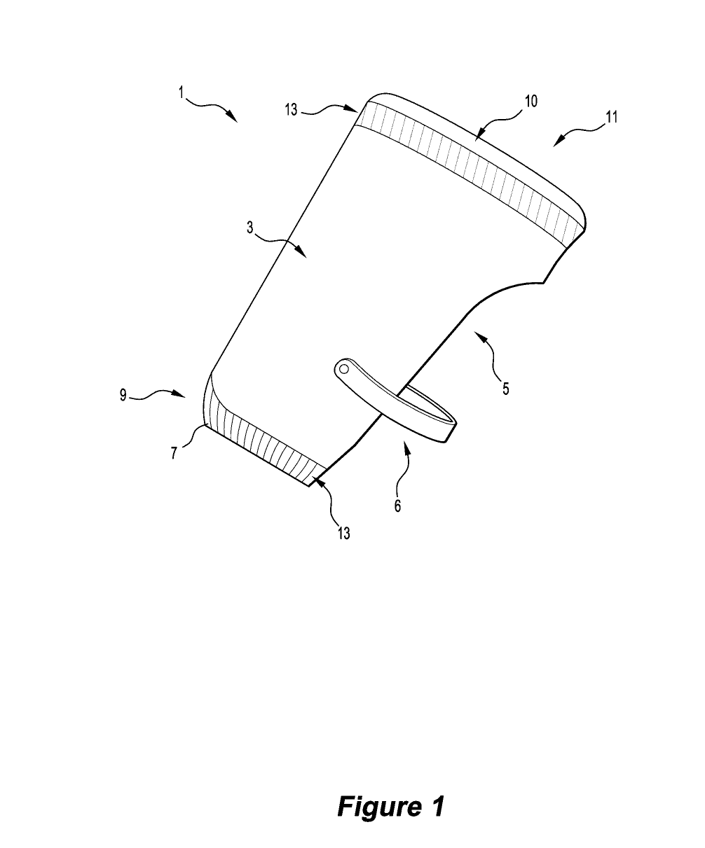

The present invention will now be described more fully hereinafter with reference to the accompanying drawings, in which various embodiments of the invention are shown. FIG. 1 illustrates a first embodiment of the protective cover 1 of the invention in side view isolated from application to any particular power tool.

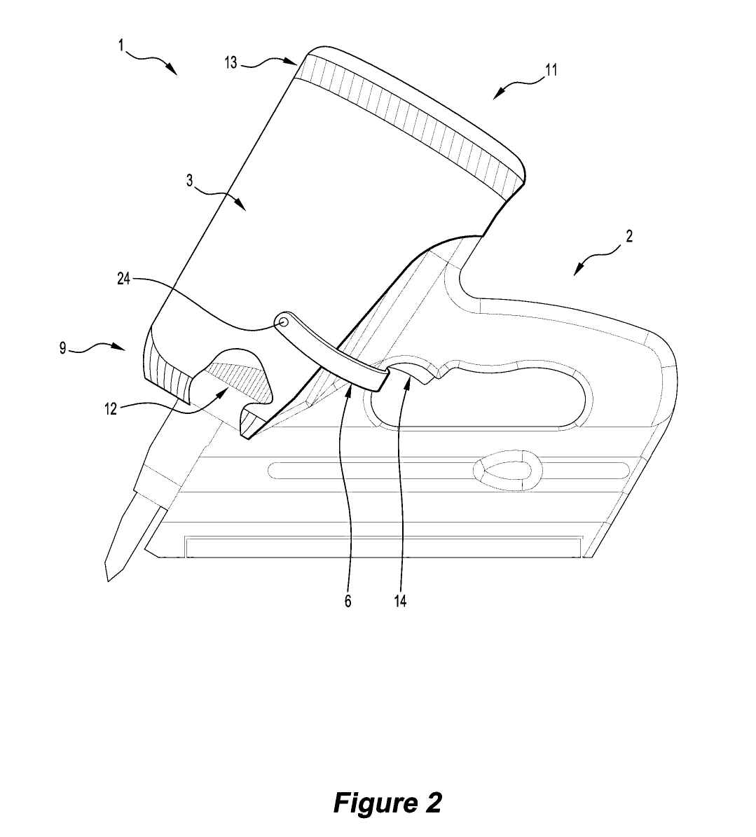

Referring now to FIGS. 1 to 4 the protective cover 1 is made up of a material adapted to absorb impact so as to deflect any potential damage to a tool 2 in the event of dropping etc. The cover 1 material can be made of compliant and resilient material particularly adapted for stretching on application to a range of tools 2 of a particular genus such that the protective cover 1 is not limited to application to a particular brand or configuration of power tool 2, but finds adaptation across a whole genus of power tools 2. For example of the type detailed in FIG. 2 being a gas powered nail gun.

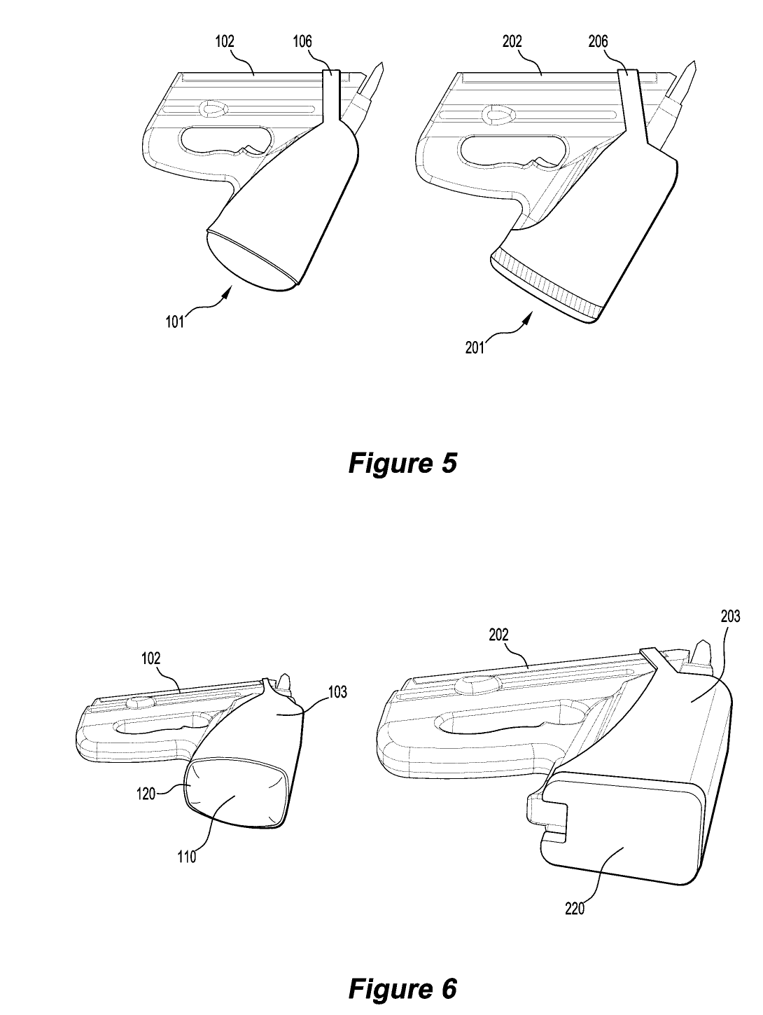

Gas powered nail guns are manufactured in a number of different sizes for use with different gauges of nail. For example, FIGS. 5 and 6 illustrate a second and third embodiment of the invention, applied to two different sizes of nail gun. FIG. 5 illustrates a “fixer” nail gun 102 and a “framer” nail gun 202. The fixer 102 is capable of firing small nails and pins, in contrast to the framer 202 which dispenses and propels a more substantial size and length of nail into a work piece.

Alternatively, the protective cover 1 can be made of a deformable material adapted to deform upon impact so as to absorb the energy of the impact and deflect any potential damage from the tool 2 to the cover 1. In such an embodiment the cover 1 is generally intended for one-off use and requires replacement after dropping.

For the purposes of the description the first embodiment of the cover 1 formed of compliant, reusable, material will be referred to herein.

The cover 1 comprises a boot 3 which can be formed of any generally compliant material capable of absorbing impacts or shock and returning to its original shape. Suitable materials include natural and synthetic rubbers; neoprene and any one of a range of available synthetic materials.

The configuration of the boot 3 is such to generally conform to the generic shape of the tool 2 in question and. in particular configured to provide protection for the most vulnerable parts of the tool 2 which can suffer damage upon dropping from a height with the damage general directed to the casing as the tool hits the ground.

The cover 1 comprises a boot 3 and a fixing means 6, wherein the boot 3 is made of generally unitary construction having an open side 5 adapted for insertion of the tool 2.

The open side 5 is of sufficient size to allow the insertion of the tool 2 within the confines so formed by the boot 3. Once the tool 2 has been inserted into the open boot 3 a fixing means 6 which is formed upon either side of the open part of the boot 3 allows the two sides of the boot 3 to be drawn together so as to snuggly engage the tool 2 and ensure an intimate and close relationship between the cover 1 to the tool 2.

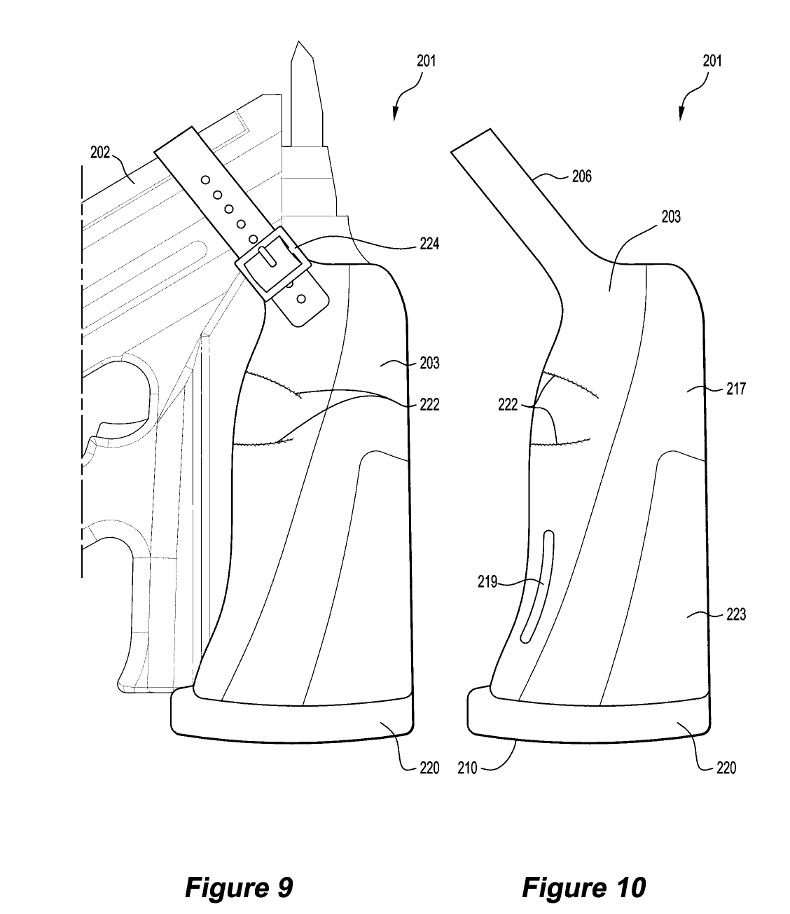

The fixing means 6 can include any one of a range of adjusters 24 for example buckles (see FIG. 9), belts, press studs (see FIGS. 1 and 2), hook and loop type fasteners. The fixing means is capable of being drawn up and tightened. Preferably, it is a fixing strap which can be looped under the trigger region 14 of the tool 2, as illustrated in FIG. 2.

In the above described manners the cover 1 is caused to be securely and straggly fitted to the tool 2 and effectively forms a protective outer skin to the tool 2 which becomes virtually unnoticed by the user after an initial period of use.

The particularly preferred materials include neoprene and other materials which are light and do not add any significant weight to the tool; but, provide maximum impact absorption and maximum physical protection against damage due to inadvertent dropping of the tool 2 in question.

As a further advantage the neoprene boot 3 can be formed from a flat template. This method of manufacture facilitates printing on the flat boot 3 before forming into the cover 1. Accordingly, there is provided a promotional or advertising space on the cover 1.

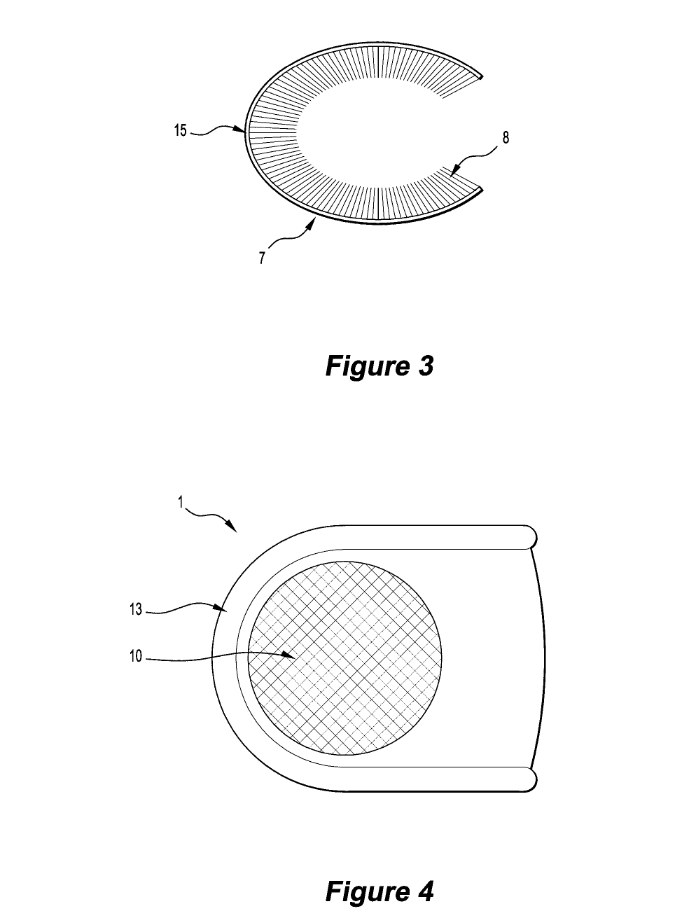

The cover 1 further includes an air outlet filter 7 positioned at the first end 9 of the cover. The air outlet filter is particularly detailed in FIG. 3 and can been seen to comprise a general U-shape collar 15 with the U-shaped collar including a plurality of air filtering bristles 8. In this manner the compliant nature of the air filter 7 and bristles 8 readily adapt and conform to the air outlet region 12 of the tool 2 during fitting and use. This enables the additional advantage and feature of the cover 1 of providing filtration and directional control of the air outlet.

In order to maximise the impact protection feature the cover 1 provides an additional reinforcing member, illustrated as reinforcing ring 13 in FIGS. 1, 2 and 4. The reinforcing ring 13 is manufactured from an impact (energy) absorbing material positioned at the second end 11 of the cover 1. The positioning of the reinforcing ring 13 is designed to correspond with the most vulnerable region of the tool 2 which generally provides the initial point of impact with the ground upon dropping the tool 2. In the example of the invention a nail gun tends to be most vulnerable at the rear portion of the gun housing.

In the particular embodiment given in FIG. 1 a second reinforcing ring (not illustrated) of impact absorbing material is provided at the first end 9 so as to protect the two most vulnerable regions of the tool 2.

It should be noted that a tool 2 typically rotates about its centre of gravity, when dropped. Accordingly some power tools are weighted to increase the probability of the tool 2 landing on a hard portion of the tool 2 and not a lighter and potentially more delicate tip. For example, a nail gun centre of gravity is disposed towards the rear of the gun and the handle. Thus, when a nail gun is dropped it will generally land on this back section as opposed to the nail dispensing tip of the tool 2.

As such, the cover 1 is designed to provide a maximum energy absorbing portion to the vulnerable or damage prone areas of a tool, by virtue of the reinforcing member 13.

References in this specification to “damage prone region” are references to the regions of a tool likely to be damaged when dropped, specifically the regions of the tool upon which the tool is likely to land, when dropped.

When a power tool 2 is dropped, the toughened plastic exterior of the tool 2 can provide some resistance to damage. However, once a predetermined point load is applied to the exterior of the tool the material will begin to crack. If the point loading is applied with sufficient strain rate, the exterior of the tool can shatter and present a health and safety risk, having sharp protruding edges where the exterior of the tool is fractured.

Where high loads are sustained at lower strain rates, the internal material of the tool can become cracked. Small cracks within a material may not be visible on the exterior of the tool. These cracks, internal to the material, weaken the structure of the material and are susceptible to propagation with any subsequent impact to the tool. Accordingly, cracks can be spreading through a tool 2 that are not apparent from a visual inspection. Once the structure is sufficiently weakened, a minor impact will fracture the exterior of the tool, rendering it unusable.

The cover 1 is configured to reduce the damage sustained when an impact to the tool 2 occurs. Furthermore the impact resistance of the cover 1 can reduce the rate at which cracks propagate within the tool from subsequent impact loads. In both of the above scenarios, the cover 1 can contribute to increasing the usable life of the tool 2.

Aside from the exterior of a tool 2, there are internal components of power tools that are susceptible to impact; for example a nail gun. A nail gun contains a gas cylinder as part of the propulsion mechanism for expelling nails from the tool. The gas cylinders are typically made from a cast iron, which is particularly brittle. This leaves the gas cylinder, within the nail gun, susceptible to fracture, if the nail gun is dropped. Damage to the gas cylinder to the extent that it is not able to contain compressed gas will render the nail gun unusable. Accordingly, the cover 1 acts to reduce the risk of damage to the gas cylinder when the nail gun is dropped. It also reduces the risk of crack propagation in the gas cylinder where a crack already exists. It reduces the risk by absorbing part of the impact energy when the nail gun impacts with a structure at a construction site, e.g. a floor, framework, scaffolding or the ground.

The cover 1 is provided with a mesh filter 10 as detailed in FIG. 4 to filter the air intake of the tool. The addition of the intake filter 10 increases the filtration of air taken into the tool 2 and allows the incorporation of a range of dedicated filters depending on the environment thereby minimizing the adverse impact on the tool 2 often experienced in hostile environments where substantial dust and debris can be drawn into the confines of the tool 2 during routine use.

It is intended that references to “debris” in this specification are intended to encompass typical building debris as found on a building or construction site, for example dust, wood shavings, wood shippings, wood fibres, dirt, sand, lint and other small particulates that may be drawn into the filter of a tool.

The filter 10 can be formed from a single layer of gauze but can also be formed from multiple layers of gauze. The gauze can be selected from a fine mesh or a coarse mesh, or combinations thereof and is predetermined in relation to the amount of air flow required to the tool 2 and the sensitivity of the tool 2 to airborne particulates and debris.

Where the filter 10 is formed from a dual gauze layer, the orientation of the two layers is off-set from one another, to refine the sensitivity of the filter 10. Specifically, the two layers of gauze are not aligned to one another.

In embodiments of the cover 1 where additional layers of gauze are incorporated into the filter 10 (2, 3, 4, or 5), each additional layer can also be off-set from the first and second layer of gauze, to further refine the filter 10.

In this manner the protective cover 1 of the invention not only provides the principle objective of furnishing impact absorption and minimization of damage during misuse by dropping or high levels of physical abrasion; but can include the additional advantage of incorporating air filtration so as to provide addition protection for the running operation of the tool 2.

In use the cover 1 of the invention finds application to a wide range of various types or genus of power tools 2 which can been accommodated by altering the configuration of the boot 3 to suit any one of a wide range of available power tools 2. The compliant and impact absorbing materials malting up the boot 3 are adapted to wrap around and protect the most vulnerable and damage prone regions of the tool 2 with the fixing means 6 or strap readily adapted to engage an appropriate portion of the tool 2 so as to securely and snuggly wrap the boot 3 around the tool 2 in question. In this manner any slippage or movement of the protective cover 1 is virtually eliminated and with a small amount of use the user of the tool 2 virtually forgets about the existence of the cover as it provides no impediment to the operational use of the tool 2.

It is contemplated that the cover 1 will be replaced every 12 to 16 months, thus the material of the boot 3 is selected to provide optimum protection over this duration. It is further contemplated that a longer-life material may be selected for different sizes of cover 1, based on commercial factors, unit cost and retail value.

Further factors in determining a suitable material for manufacture of the cover 1 is the environment in which the tool 2 is to be operated, chemical compatibility, toxicity and UV sensitivity.

A high tear strength is desirable to increase the durability of the reinforcing member 13 and thereby the cover 1. A tear strength of about 12.5 kN/m is considered appropriate on an industrial worksite, although it is contemplated that home users and weekend DIY users will may not require the same level of durability in a cover 1 as a tradesperson or professional user.

When selecting suitable materials for reinforcing member 13 and boot 3, materials that are easily pigmented offer a commercial benefit, as portions of the cover 1 are manufactured in a range of colours or a given “brand” colour for use with a particular tool 2. Furthermore, different colours can be used to designate different sizes of cover 1 or different energy absorbing capabilities.

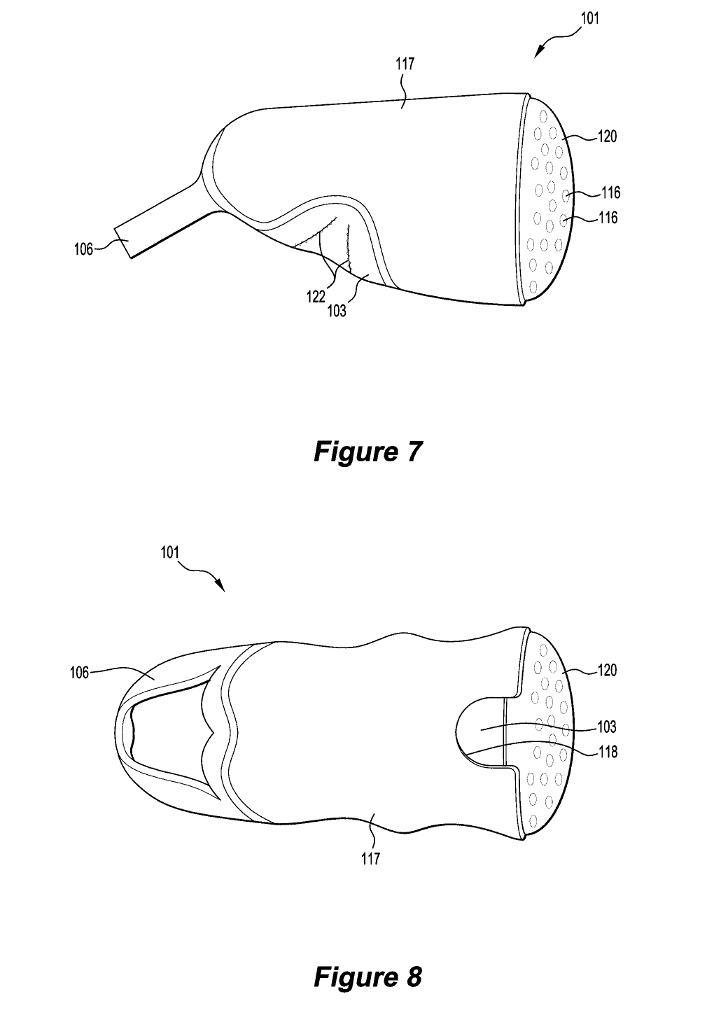

Turning to FIGS. 7 and 8, which illustrate a second embodiment of the invention: the cover 101 is formed from a first layer of material that is shaped with darts 122. These darts 122 or pleats provide form and general shape to the boot 103, assisting with stretching the boot 103 over the tool 102.

In this second embodiment, the cover 101 comprises a boot 103 and an outer skin 117, thereby providing at least two layers of material to protect the damage prone regions of the tool 102. At least one of the boot 103 or the outer skin 117 is energy absorbent. Preferably, each layer of the boot 103 and the outer skin 117 is energy absorbent to provide additional protection for the tool 102.

As illustrated in FIGS. 7 and 8, the outer skin 117 is not tailored to the same template as the boot 103, thereby giving further shape to the cover 101 by tensioning the material and taking the general form of a tool 102 before being stretched over the tool 102.

The outer skin 117 can mirror the boot 103 in shape and size. However, the outer skin 117 and the boot 103 can be varied in shape and/or size. In this manner, the boot 103 provides a connection means between the tool 102 and the outer skin 117, and the denser skin 117 provides the energy absorbing characteristics of the cover 101.

The boot 103 and the outer skin 117 are made from the same density and same thickness of material; however, the panels of the outer skin 117 are tailored or shaped to assist the cover 101 in conforming to the shape of the tool 102. Closer conformation between the cover 101 and the tool 102 provides for better protection of the tool 102, as there is less likelihood of the tool 102 landing on an unprotected portion. Furthermore, the close conformity of the cover 101 to the tool 102 reduces the chances of the cover 101 gaping and sagging which can provide a hindrance and a safety hazard on a construction site.

In the second embodiment, where the cover 101 is formed from both the boot 103 and the outer skin 117, the two layers can be sealed to each other. Alternatively, portions of the boot 103 and the outer skin 117 can remain unconnected, thereby providing at least one cavity 118 in the cover 101, as illustrated in FIG. 8.

This cavity 118 provides a housing in which to fit heating or cooling means to moderate the temperature of the tool 102 in use. For example, when the tool 102 is used with a cover 101 in a particularly cold climate, there is a chance that the internal mechanisms can become stuck or frozen. Particularly susceptible to the cold, is the cast iron gas cylinder within the tool 102 that provides the propulsion mechanism for the nails to be expelled from the gun. By providing a heating means such as chemical sachets or even a thin wire, through which a heating current can flow, the ambient temperature effects on the tool 102 can be overcome or at least reduced.

In this second embodiment, the fixing means 106 comprises a fixed loop or strap, as illustrated in FIGS. 7 and 8. The fixed loop is permanently affixed to the boot 103. The loop or strap is formed from a resilient material such as natural and synthetic rubbers; neoprene and any one of a range of available synthetic materials, and can be stretched over the tool 102 to provide a tightening means in the tensioning of the material of the strap. The loop or strap can be integrally formed from the material of the boot 103.

The template for the boot 103 is a generally triangular shape, having a broad base at the second end 111 to surround the tool 102 and an apex at the first end 109 that surrounds the active end of the tool 102. The apex has an aperture for receiving a portion of the tool 102, wherein the peripheral material, around the aperture, becomes tensioned when placed around the tool 102, thereby creating the fixing means 106 in the form of an integral collar. The fixing means 106 when stretched around the tool 102 is illustrated in FIG. 12, from below the tool 102. The tension in the boot 103 created by stretching the fixing means 106 around the tool 102, assists in holding the cover 101 snuggly around the tool 102 and reduces gaping.

In this second embodiment of the invention, the reinforcement member is provided by a resilient base 120, as illustrated in FIGS. 7 and 8.

The base 120 is made from a high density rubber (if reusable) or foam (in a non-reusable embodiment) and is disposed within the cover 101 at the rear of the tool 102. In FIG. 7 the base 120 can be seen to form part of the cover 101 at the second end 111 of the boot 103.

The base 120 is generally square in plan view, with a peripheral lip running at least partially around its boundary. The lip provides additional impact absorbing coverage around the second end 111 of the tool 102, and also provides a cup-like shape for sitting over the exterior of the tool 102 and positioning the cover 101 thereon.

The base 120 is especially advantageous for larger and heavier tools 102 where a greater amount of energy is to be absorbed. On the understanding that impact energy is based on a relationship between mass and velocity [kinetic Energy=½ mv²] the heavier the tool 102, and/or the higher the fall, the more energy will need to be absorbed to protect the tool 102 from damage.

The base 120 is made from a low viscosity, two-component polyurethane elastomer, although alternative resilient elastomers and energy absorbing foams can be employed. The material has approximately 200% elongation, a tensile strength of 2 MPs and a specific gravity of about 1 gm/cc.

The shelf life of the material is of importance as the level of protection offered to a tool 102 is degraded as the materials energy absorption characteristics deteriorate.

The base 120 is permanently affixed to the boot 103, either by sewing or an adhesive. However, it is contemplated that the base 120 can be removable from the boot 103 to facilitate cleaning of both the base 120 and the boot 103.

The cover 101 further comprises an stir inlet filter 110 permanently affixed to the boot 103. In this second embodiment the filter 110 is incorporated within the base 120, as illustrated in FIGS. 7 and 8, as a plurality of apertures 116.

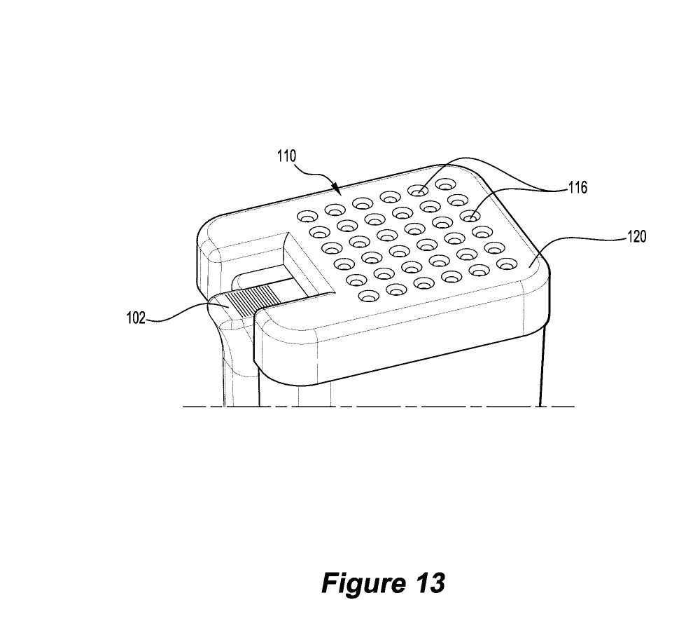

The apertures 116 allow for air flow through the cover 101 and into the tool 102, as illustrated in FIG. 13. The thicker and denser the base 120, the more likelihood that ventilation will be required to prevent the cover 101 from hampering the operation of the tool 102. In this manner, the filter 110 can be integrally formed with the base 120.

In alternative embodiments, it is contemplated that the filter 110 could be formed from a mesh or gauze module, releasably attached to the base 120, to facilitate cleaning and replacement of the filter 110.

Where the filter 110 is releasably attached to the boot 103 or the reinforcing member 113 or base 120, the filter 110 is formed as a removable cassette. The filter cassette can comprise a single layer or multiple layers of gauze. The filter cassette, which can be inserted and removed from either of the boot 103 or the reinforcing member 113 or the base 120, can be rigid or deformable. The cassette can be removed for cleaning in water or with suction, as required.

In a third embodiment the cover 201 is provided with a secondary layer 217 and a tertiary layer 223 of energy absorbing material, as illustrated in FIGS. 9 and 10.

This third embodiment provides protection for a larger form of tool 202, referred to as a “framer”. The framer expels a large, heavy duty nail, and as such is expelled from a larger and heavier tool 202. To account for the additional weight of some tools 202, the cover 201, provides a tertiary layer 223 of neoprene or alternative energy absorbing material, to provide additional impact resistance. The cover 201 illustrated in FIGS. 9 and 10 also uses darts 222 to shape the boot 203 to a tool 202 and provides side air vents 219 and a fixing means 206 having an adjustor 224 in the form of a buckle.

To provide further protection to heavier tools 202, the base 220 of the cover 201 is manufactured from a material having additional energy absorbing capabilities. Alternatively, the base 220 is configured, to be thicker, thereby providing a greater volume of energy absorbing material around the damage prone regions of the tool 202.

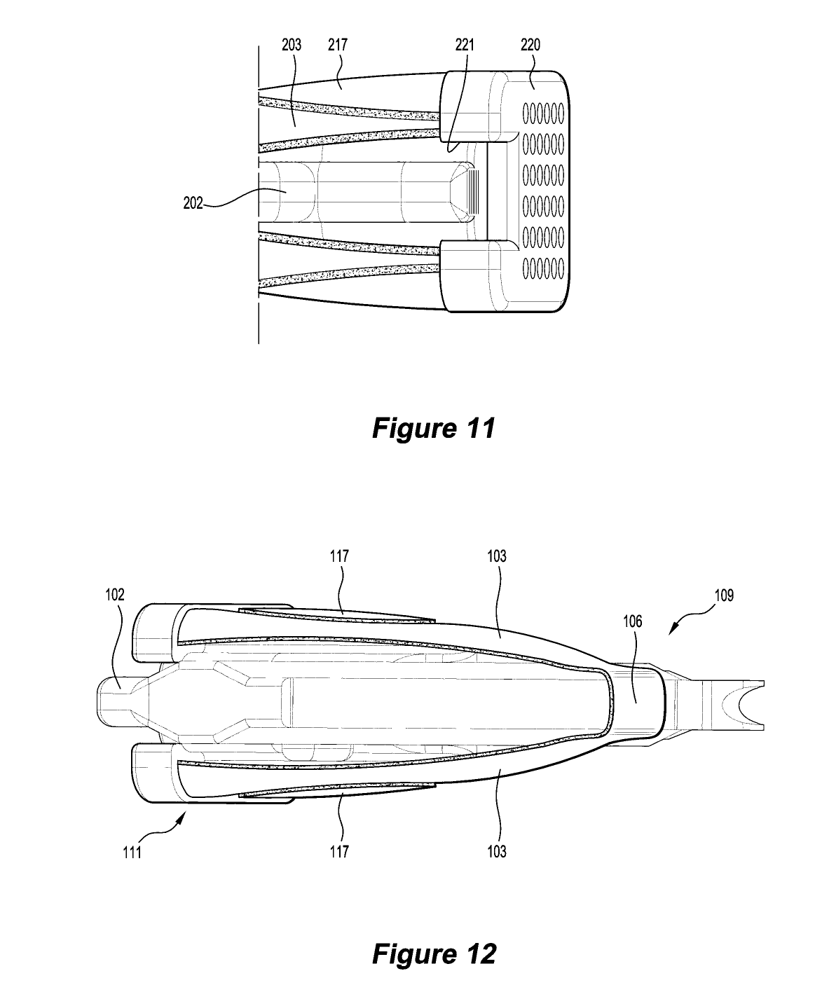

The base 220 is generally square in plan view, with a peripheral lip 221 running at least partially around its boundary. The lip 221 provides additional impact absorbing coverage around the second end 211 of the tool 202, and also provides a cup-like shape for sitting over the exterior of the tool 202 and positioning the cover 201 thereon. The geometry of the base 220 is illustrated in FIG. 11, where the base 220 is cutaway to reveal the section therethrough. It is contemplated that an air filter 210 in the form of a cassette can be housed within the base 220. The filter can be permanently attached or removably attached to facilitate cleaning or replacement.

The base 220 is made from moulding or casting and can be controlled to a high degree of dimensional accuracy.

The different densities of material used to manufacture the base 220 will provide differing levels of energy absorption, and thereby protection. Alternatively, the density of the base 220 need not be varied, instead the thickness of the base 220 can be increased to provide for additional energy absorption. However, increasing the depth and size of the base 220 can become cumbersome and awkward for the person handling the tool 202.

The boot 203 is further provided with at least one side air vent 219 to facilitate sufficient air flow around and to the inner mechanisms of the tool 202 whilst protected by a cover 201, illustrated in FIG. 10. The side air vent 219 can be located at more than one location around the boot 203 to provide optimum cooling of the tool 202. In some embodiments, multiple side air vents 219 are provided to coincide with the venting arrangements of a particular tool 202.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and modifications may be made to the above-described embodiments, without departing from the scope of the following claims. The invention finds ready application throughout a wide range of available power tools; therefore, present embodiments are to be considered in all respects as illustrative and not restrictive.

1-20. (canceled)

21. A protective cover for a power tool, comprising an impact absorbing boot configured to fit the genus of the power tool, the boot being adapted to cover damage prone regions of the power tool, the boot having an opening for inserting the tool and having a fixer traversing the opening.

22. The cover of claim 21, wherein the boot is formed of a compliant material providing the impact absorption and adapted for repeated use.

23. The cover of claim 21, wherein the boot is formed of a deformable material adapted to absorb the impact by deformation and not intended for repeated use.

24. The cover of claim 21, wherein the boot comprises a primary and a secondary layer, at least one of the layers being formed of an impact absorbing material.

25. The cover of claim 24, wherein a cavity is formed between the primary and secondary layers of the boot.

26. The cover of claim 25, wherein the cavity is configured to retain at least one of a heater or a cooler therein.

27. The cover of claim 21, wherein the fixer is removably attached to either side of the opening.

28. The cover of claim 21, wherein the fixer includes an adjustor to draw the boot into close proximity to the power tool and ensure snug fitting of the cover to the power tool.

29. The cover of claim 21, further comprising an air outlet filter associated with the boot.

30. The cover of claim 29, wherein the air outlet filter includes a plurality of fine bristles adapted to conform to the shape of the air output region of the tool.

31. The cover of claim 29, wherein the air outlet filter is U-shaped and fitted to a first end of the boot.

32. The cover of claim 21, further including a reinforcing member of compliant material at first and/or second ends of the cover, to provide additional impact resistance at the damage prone region of the tool.

33. The cover of claim 32, wherein the reinforcing member comprises a ring.

34. The cover of claim 32, wherein the reinforcing member is configured to allow air flow therethrough.

35. The cover of claim 32, further comprising an air inlet filter at the second end of the cover.

36. The cover of claim 35, wherein the air inlet filter comprises a mesh screen to filter building debris.

37. The cover of claim 35, wherein the reinforcing member comprises the air inlet filter.

38. The cover of claim 35 wherein the air inlet filter comprises a plurality of layers of mesh screen, each layer configured to be displaceable relative to the other.

39. The cover of claim 21, wherein the boot includes a battery access port.

40. The cover of claim 21, wherein the boot further comprises a side air vent.
